(19) United States
(12) Patent Application Publication
(10) Pub. No.: US 2008/0032009 A1
(43) Pub. Date: Feb. 7, 2008

(54) APPLE COMPOSITION AND METHOD

(76) Inventors: Kimberly Ann Priest, Hamden, CT (US); John Eaton, Oxford, CT (US)

Correspondence Address: CANTOR COLBURN, LLP, 55 GRIFFIN ROAD SOUTH, BLOOMFIELD, CT, 06002, US

(21) Appl. No.: 11/829,432

(22) Filed: Jul. 27, 2007

Related U.S. Application Data
(60) Provisional application No. 60/821,294, filed on Aug. 3, 2006.

(51) Int. Cl. A23L 1/025; A23L 3/00

(52) U.S. Cl. 426/238; 426/533; 426/589

(57) ABSTRACT

A smooth apple composition is prepared by ultrasonically processing a composition that includes at least 85% apple sauce. The smooth apple composition, which may optionally be derived only from apples and water, has physical and sensory properties that make it useful in a wide range of food and beverage products.

### CROSS REFERENCE TO RELATED APPLICATIONS

This application claims the benefit of U.S. Provisional Application Ser. No. 60/821,294 filed Aug. 3, 2006. This provisional application is incorporated herein by reference.

### BACKGROUND OF THE INVENTION

The present invention relates to a fruit composition useful as an ingredient in food and beverages. In particular, the invention relates to a smooth apple composition prepared from apple sauce.

Manufacturers of food and beverage products strive to improve the nutritional quality of their products while maintaining or improving taste and mouthfeel. For example, there is a strong desire to reduce the fat and refined sugar content of foods and beverages without adversely affecting their sensory characteristics.

U.S. Pat. No. 5,849,350 to Ashourian et al. describes a process for preparing a pourable fruit product by homogenizing fresh and processed fruits, fruit purees, and fruit juices. However, this process requires both fruit puree and fruit juice as inputs, and the demonstrated embodiments all have at least five ingredients as inputs to the homogenization process.

U.S. Patent No. 6,383,546B1 to Powrie et al. describes a process for producing a universal fruit base, which is an apple mash-polysaccharide mixture. The addition of modified starch and xanthan gum is required to prevent sedimentation of particulates. This process also requires that the product have predominantly intact single cells.

International Patent Application Publication No. WO 2004/112502 of Barraclough et al. describes a process for producing shelf-stable fruit products by fruit cell fragmentation. However, the product of this process includes fruit chunks having dimensions on the order of 1 to 15 millimeters, and these relatively large chunks limit the use of the product in foods or beverages requiring a smooth texture. Similarly, although apple sauce has sometimes been used as a fat substitute in baking, its texture is too coarse for use in smooth beverage products.

There is therefore a need for a smooth, fruit-based food and beverage base that can be simply prepared from fruit without requiring stabilizers, numerous ingredients, or the preparation of fruit juice as an intermediate step.

### BRIEF SUMMARY OF THE INVENTION

The above-described and other drawbacks and disadvantages of the prior art are alleviated by a method of preparing an apple base for food and beverage products, comprising: processing an apple composition comprising at least 85 weight percent apple sauce with ultrasonic vibrations to produce an apple base comprising particles, wherein 90 volume percent of the particles have a diameter less than or equal to 450 micrometers.

Another embodiment is a method of preparing an apple base for food and beverage products, comprising: processing an apple composition comprising at least 95 weight percent apple sauce with ultrasonic vibrations to produce an apple base; wherein the apple sauce is prepared from ingredients consisting of apples, water, and optionally, ingredients selected from the group consisting of apple juice, salt, organic acids added for the purpose of acidification, nutritive carbohydrate sweeteners, spices, natural flavorings, artificial flavorings, antioxidants, and mixtures thereof; wherein the apple base has a percent soluble solids of about 9 to about 11 brix; wherein the apple base comprises particles wherein 90 volume percent of the particles have a diameter less than or equal to 350 micrometers; and wherein the apple base comprises less than 2 percent intact cells.

Another embodiment is a method of preparing an apple base for food and beverage products, comprising: dividing apples into portions; steam cooking the apple portions to produce a cooked puree; pulping the cooked puree to produce an apple sauce; and processing the apple sauce with ultrasonic vibrations to produce an apple base comprising particles, wherein 90 volume percent of the particles have a diameter less than or equal to 450 micrometers.

Another embodiment is an apple base for food and beverage products, wherein the apple base is prepared from ingredients consisting of apples, water, and optionally, not greater than 5 weight percent total of ingredients selected from the group consisting of apple juice, salt, organic acids added for the purpose of acidification, nutritive carbohydrate sweeteners, spices, natural flavorings, artificial flavorings, antioxidants, and mixtures thereof; and wherein the apple base comprises particles, wherein 90 volume percent of the particles have a diameter less than or equal to 450 micrometers.

Other embodiments, including apple bases prepared by the above methods, are described in detail below.

### DETAILED DESCRIPTION OF THE PREFERRED EMBODIMENTS

One embodiment is a method of preparing an apple base for food and beverage products, comprising: processing an apple composition comprising at least 85 weight percent apple sauce with ultrasonic vibrations to produce an apple base comprising particles, wherein 90 volume percent of the particles have a diameter less than or equal to 450 micrometers. The present inventor has discovered that ultrasonic treatment of an apple composition consisting largely or entirely of applesauce yields a smooth fruit base that is suitable for use in a wide variety of foods and beverages. In some embodiments, the apple base may be prepared using apples and water as the only material inputs, thereby avoiding the use of juices and additives and improving the nutritional value of the food or beverage in which it is used.

The apple base is prepared by a method comprising processing an apple composition with ultrasonic vibrations. The frequency of ultrasonic vibration ranges from about 15 kilohertz to about 10 megahertz. Within this range, the frequency may be at least about 20 kilohertz. Also within this range, the frequency may be up to about 1 megahertz, or up to about 100 kilohertz. Equipment for ultrasonic treatment of fluids is known in the art and includes, for example, sonic whistles, piezoelectric transducers, magnetostrictive transducers, and combinations thereof.

In some embodiments, ultrasonic treatment utilizes a sonic whistle. In a sonic whistle, a fluid is pumped with pressure through an orifice forming a flat, high pressure jet stream. The pressure may be, for example, about 4 to about 40 megapascals. This jet is directed toward the edge of a flat, flexible steel blade, so that impingement of the jet on the blade causes the blade to vibrate and thus cause intense ultrasonic vibrations within the liquid itself. The orifice/blade distance may be varied to obtain maximum cavitation for the particular fluid being treated. Cavitation takes place continuously producing violent local pressure changes in the liquid. The high level of cavitation, combined with shear and turbulence in the mixing chamber, shatters particles. The process is completed in microseconds so there is a very high throughput of material through the equipment. The feed is uniformly treated and there is little or no heating effect. In some embodiments, the apple composition may be processed with two or more passes through the sonic whistle. Sonic whistles are commercially available and include, for example, those sold under the trade name Sonolator by Sonic Engineering Corporation.

When the ultrasonic treatment utilizes a piezoelectric transducer or a magnetostrictive transducer, the apparatus typically comprises a generator to generate electrical oscillations with a frequency in the ultrasonic range, the transducer to convert the electrical oscillations into mechanical vibrations, and a sonotrode to transmit the mechanical vibrations from the transducer to the material treated. Ultrasonic processors using piezoelectric or a magnetostrictive transducers are commercially available as, for example, the 16 Kilowatt UIP 16000 industrial homogenizer from Hielscher USA.

The temperature at which the apple composition is processed may be, for example about 5 to about 100° C. Within this range, the temperature may be at least about 10° C., or at least bout 20° C. Also within this range, the temperature may be up to about 80° C., or up to about 60° C., or up to about 40° C., or up to about 30° C. The process may be conveniently operated at ambient temperature.

Ultrasonic processing is an energy efficient process. For example, ultrasonic processing may be conducted with an energy of about 0.1 to about 0.5 kilojoule per kilogram of apple composition.

The method may, optionally, further comprise pasteurizing the apple base. Pasteurization may occur during or subsequent to processing with ultrasonic vibrations.

In the present method, ultrasonic processing is conducted on an apple composition comprising at least 85 weight percent apple sauce. In some embodiments, the apple composition may comprise at least 90 weight percent apple sauce, or at least 95 weight percent apple sauce, or at least 99 weight percent apple sauce. Apple sauce is a cooked product that may be prepared from ingredients including apples, water, and, optionally, ingredients such as apple juice, salt (sodium chloride), organic acids added for the purpose of acidification (that is, organic, food-grade acids), nutritive carbohydrate sweeteners, spices, natural flavorings, artificial flavorings, antioxidants (such as erythorbic acid and ascorbic acid), and mixtures thereof. In some embodiments, the apple sauce ingredients consist of apples and water. The water used in the preparation of apple sauce is typically introduced as steam used to cook the apples.

In addition to the apple sauce, the ultrasonically processed apple composition may optionally include fruit juices, fruit purees, whey, milk protein, soy protein, thickening agents, emulsifiers, vitamins, minerals, flavoring agents, sweeteners, preservatives, coloring agents, and the like, and combinations thereof. In some embodiments, the apple composition consists of apple sauce. When the apple sauce is prepared from ingredients consisting of apples and water, and the apple composition consists of apple sauce, the resulting apple base is prepared from ingredients consisting of apples and water. In some embodiments, ingredients other than apples and water are present in an amount of not greater than 5 weight percent, based on the total weight of the apple sauce. In some embodiments, the apple composition comprises less than 5 weight percent milk protein. In some embodiments, the apple composition does not comprise milk protein (for example, no milk protein is intentionally added to the apple composition). In some embodiments, the apple composition does not comprise apple juice. In some embodiments, the apple composition does not comprise any fruit juice.

Apple sauce typically includes a substantial fraction of particles greater than 500 micrometers. Ultrasonic treatment reduces the size of such particles. In the present method, the apple base produced by ultrasonic treatment has particles 90 volume percent of which have a diameter less than or equal to 450 micrometers, specifically less than or equal to 400 micrometers, more specifically less than or equal to 350 micrometers. The small particle sizes created by ultrasonic processing improve the mouthfeel of food and beverage products prepared using the apple base as an ingredient. Particles size distribution may be determined, for example, by using known laser light scattering methods. Suitable equipment for determining particle size distribution includes, for example, the Mastersizer 2000 available from Malvern Instruments Limited.

In some embodiments, the apple base may have a percent soluble solids of about 9 to about 11 brix at 20° C. Within this range, the percent soluble solids may be at least about 10 brix. Percent soluble solids (also known as “brix” or “percent brix”) may be determined by refractometry. Suitable equipment for determining percent soluble solids includes, for example, refractometer model number RFM840 available from Bellingham Stanley.

The ultrasonic processing typically disrupts most of the intact cells in the apple sauce. Thus, in some embodiments, the apple base has less than or equal to 5 percent intact cells, or less than or equal to 3 percent intact cells, or less than or equal to 2 percent intact cells. These values of percent intact cells are expressed relative to a value of 100 percent intact cells based on whole apple. The percent intact cells may be determined on commercially available hemocytometers, such as, for example, a Levy Double Neubauer Counting Chamber 4000 available from Clay Adams.

The apple base may exhibit significantly reduced viscosity relative to the apple sauce from which it is made. For example apple sauce may exhibit a viscosity of 10,000 centipoise or greater at 25° C., whereas the apple base may exhibit a viscosity of less than or equal to 5,500 centipoise at 25° C., or less than or equal to 5,000 centipoise at 25° C. Viscosity in centipoise may be measured using commercially available equipment, such as, for example, a Brookfield viscometer operated for one minute at 12 rotations per minute with spindle number 3.

The viscosity of the apple base may also be expressed as a Bostwick viscosity. For example, the apple base may have a Bostwick viscosity of about 6 to about 9 centimeters per 30 seconds at 18° C. Within this range, the Bostwick viscosity may be at least about 7 centimeters per 30 seconds. Also within this range, the Bostwick viscosity may be up to about 8 centimeters per 30 seconds. Bostwick viscosity may be measured using a Bostwick consistometer.

One embodiment is a method of preparing an apple base for food and beverage products, comprising: processing an apple composition comprising at least 95 weight percent apple sauce with ultrasonic vibrations to produce an apple base; wherein the apple sauce is prepared from ingredients consisting of apples, water, and optionally, ingredients selected from the group consisting of apple juice, salt, organic acids added for the purpose of acidification, nutritive carbohydrate sweeteners, spices, natural flavorings, artificial flavorings, antioxidants, and mixtures thereof; and wherein the apple base has a percent soluble solids of about 9 to about 11 brix, particles, wherein 90 volume percent of the particles have a diameter less than or equal to 350 micrometers, and less than 2 percent intact cells. The apple composition may, optionally, consist of the apple sauce. The apple sauce may, optionally, be prepared from ingredients consisting of apples and water.

The method may, optionally, further comprise preparing the apple sauce used in the apple composition. Thus, one embodiment is a method of preparing an apple base for food and beverage products, comprising: dividing apples into portions; steam cooking the apple portions to produce a cooked puree; pulping the cooked puree to produce an apple sauce; and processing the apple sauce with ultrasonic vibrations to produce an apple base comprising particles, wherein 90 volume percent of the particles have a diameter less than or equal to 450 micrometers, specifically less than or equal to 400 micromters, more specifically less than or equal to 350 micrometers. The apple sauce may, optionally, be prepared from ingredients consisting of water and apples. The apple base may, optionally, consist of the processed apple sauce (in other words, ultrasonic processing may be conducted on apple sauce alone, with no additional ingredients added to the apple base after ultrasonic processing). The step of dividing the apples into portions includes any operation effective to expose the apple flesh and may comprise, for example, chopping, grating, or processing the apples through a screen. The apples may, optionally, be peeled and/or cored during preparation of the apple sauce.

The invention extends to an apple base prepared by any of the above methods.

One embodiment is an apple base for food and beverage products, wherein the apple base is prepared from ingredients consisting of apples, water, and optionally, not greater than 5 weight percent total of ingredients selected from the group consisting of apple juice, salt, organic acids added for the purpose of acidification, nutritive carbohydrate sweeteners, spices, natural flavorings, artificial flavorings, antioxidants, and mixtures thereof; and wherein the apple base comprises particles, wherein 90 volume percent of the particles have a diameter less than or equal to 450 micrometers, specifically less than or equal to 400 micrometers, more specifically less than or equal to 350 micrometers. The apple base may, optionally, have a percent soluble solids of about 9 to about 11 brix. The apple base may, optionally, have less than or equal to 2 percent intact cells.

The apple base is suitable for use in a variety of food and beverage products. For example, the apple base may be used as a fat substitute in baked goods. The apple base is also useful as an ingredient in snack products such as chips and apple puffs. The apple base may also be used in puddings soups, creamy beverages such as smoothies, and carbonated beverages. In addition to food and beverage applications, the apple base may be useful in personal care products such as shampoos and cosmetics.

Although the invention has been described in terms of processing an apple composition, it will be understood that the ultrasonic processing method can be applied to other fruit and vegetable compositions. For example, the method can be applied to uncooked or cooked purees of mango, papaya, banana, pineapple, peas, tomato, and mixtures thereof optionally in combination with apple. In some embodiments, the method comprises removing seeds, if any, from the fruit or vegetable prior to or during preparation of the puree that is subjected to ultrasonic processing.

The invention is further illustrated by the following non-limiting examples.

### EXAMPLE 1

### Comparative Examples 1-3

These examples illustrate preparation of an apple base using apples and water as the only material inputs. They also illustrate the properties of compositions prepared using homogenization instead of ultrasonic processing.

All examples used apple sauce as a starting material. The apple sauce starting material, designated Comparative Example 1 (“C. Ex. 1” in Table 1) was prepared by dividing apples, steam cooking the divided apples, pulping the steam-cooked apples, pasteurizing the cooked, pulped apples, and bottling the pasteurized apple sauce. The properties of the apple sauce are presented in Table 1.

For Example 1, the apple sauce (prepared from ingredients consisting of apples and water) was ultrasonically processed at about 23° C. using a Sonolator Model A from Sonic Engineering Corporation, operated at a pressure of 10.34 megapascals (1,500 pounds per square inch).

Comparative Examples 2 and 3 were prepared at about 23° C. using an APV two-stage homogenizer operated at 10.34 megapascals (1,500 pounds per square inch) and 14.48 megapascals (2,100 pounds per square inch) pressure, respectively.

Properties of the resulting processed compositions are summarized in Table 1. Viscosity, expressed in centipoise (cPs), was measured on a Brookfield viscometer operated for one minute at 12 rotations per minute with spindle number 3. Bostwick viscosity, expressed in centimeters per 30 seconds, was measured at 18° C. (64° F.) on a Bostwick consistometer. Percent soluble solids, expressed in brix, was measured at 20° C. on a Bellingham RFM840 automatic digital refractometer. The particle size distribution, expressed as the particle size, in micrometers, for which 90 volume percent of the particles in the sample are that size or smaller, was determined on a Malvern Mastersizer S. In other words, a particle size value of 334 micrometers means that 90 volume percent of the particles in the sample have a particle size less than or equal to 334 micrometers. The percentage of intact cells was determined at 20° C. on a Clay Adams Levy Double Neubauer Counting Chamber 4000 hemocytometer. The reference of 100% intact cells corresponds to whole apple. The results show that Example 1, prepared by ultrasonic process, has significantly smaller particle size than Comparative Examples 2 and 3 prepared by homogenization.

TABLE 1

| | Ex. 1 | C. Ex. 1 | C. Ex. 2 | C. Ex. 3 |
|---|---|---|---|---|
| Processing | ultrasonic | — | homogen'n | homogen'n |
| technique | processing | | | |
| Processing pressure | 10.34 | — | 10.34 | 14.48 |
| (MPa) | | | | |
| Viscosity (cPs) | 4,930 | 11,550 | 5,370 | 5,300 |
| Bostwick viscosity | 7.8 | 3.2 | 6.4 | 7.4 |
| (cm/30 sec at | | | | |
| 64° F.) | | | | |
| % Soluble solids | 10.33 | 10.14 | 10.20 | 10.18 |
| (brix) | | | | |
| 90 volume % | 334 | 750 | 400 | 389 |
| particle size | | | | |
| (micrometers) | | | | |
| % Intact Cells | 1.8 | 31.3 | 1.7 | 1.6 |

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A method of preparing an apple base for food and beverage products, comprising:
processing an apple composition comprising at least 85 weight percent apple sauce with ultrasonic vibrations to produce an apple base comprising particles, wherein 90 volume percent of the particles have a diameter less than or equal to 450 micrometers.

2. The method of claim 1, wherein 90 volume percent of the particles have a diameter less than or equal to 350 micrometers.

3. The method of claim 1, wherein the apple base has a percent soluble solids of about 9 to about 11 brix.

4. The method of claim 1, wherein the apple base has less than or equal to 5 percent intact cells.

5. The method of claim 1, wherein the apple base has a Bostwick viscosity of about 7 to about 8 centimeters per 30 seconds at 18° C.

6. The method of claim 1, wherein said processing with ultrasonic vibrations comprises processing at a pressure of about 8 to about 21 megapascals.

7. The method of claim 1, wherein said processing with ultrasonic vibrations comprises processing at a temperature of about 5 to about 100° C.

8. The method of claim 1, wherein said processing with ultrasonic vibrations comprises processing with an energy of about 0.1 to about 0.5 kilojoule per kilogram of apple composition.

9. The method of claim 1, wherein the ultrasonic vibrations are, generated by a sonic whistle, a piezoelectric transducer, or a combination thereof.

10. The method of claim 1, wherein the apple composition consists of apple sauce.

11. The method of claim 1, wherein the apple sauce is prepared from ingredients consisting of
apples,
water, and
optionally, ingredients selected from the group consisting of apple juice, salt, organic acids added for the purpose of acidification, nutritive carbohydrate sweeteners, spices, natural flavorings, artificial flavorings, antioxidants, and mixtures thereof.

12. The method of claim 11, wherein the optional ingredients are present in an amount of not greater than 5 weight percent, based on the total weight of the apple sauce.

13. The method of claim 1, wherein the apple sauce is prepared from ingredients consisting of water and apples.

14. The method of claim 13, wherein the apple composition consists of the apple sauce.

15. The method of claim 1, further comprising pasteurizing the apple base.

16. A method of preparing an apple base for food and beverage products, comprising:
processing an apple composition comprising at least 95 weight percent apple sauce with ultrasonic vibrations to produce an apple base;
wherein the apple sauce is prepared from ingredients consisting of
apples,
water, and
optionally, ingredients selected from the group consisting of apple juice, salt, organic acids added for the purpose of acidification, nutritive carbohydrate sweeteners, spices, natural flavorings, artificial flavorings, antioxidants, and mixtures thereof; and
wherein the apple base has a percent soluble solids of about 9 to about 11 brix;
wherein the apple base comprises particles, wherein 90 volume percent of the particles have a diameter less than or equal to 350 micrometers; and
wherein the apple base comprises less than 2 percent intact cells.

17. The method of claim 16, wherein the apple composition consists of apple sauce, and wherein the apple sauce is prepared from ingredients consisting of water and apples.

18. A method of preparing an apple base for food and beverage products, comprising:
dividing apples into portions;
steam cooking the apple portions to produce a cooked puree;
pulping the cooked puree to produce an apple sauce; and
processing the apple sauce with ultrasonic vibrations to produce an apple base comprising particles, wherein 90 volume percent of the particles have a diameter less than or equal to 450 micrometers.

19. The method of claim 18, wherein 90 volume percent of the particles have a diameter less than or equal to 350 micrometers.

20. The method of claim 18, wherein the apple sauce is prepared from ingredients consisting of water and apples, and wherein the apple base consists of the processed apple sauce.

21. The method of claim 18, wherein said dividing comprises one or more of chopping, grating, and processing through a screen.

22. The method of claim 18, further comprising peeling the apples.

23. The method of claim 18, further comprising coring the apples.

24. An apple base prepared by the method of claim 1.

25. An apple base prepared by the method of claim 16.

26. An apple base prepared by the method of claim 17.

27. An apple base prepared by the method of claim 18.

28. An apple base prepared by the method of claim 19.

29. An apple base prepared by the method of claim 20.

30. An apple base for food and beverage products:
wherein the apple base is prepared from ingredients consisting of
apples,
water, and
optionally, not greater than 5 weight percent total of ingredients selected from the group consisting of apple juice, salt, organic acids added for the purpose of acidification, nutritive carbohydrate sweeteners, spices, natural flavorings, artificial flavorings, antioxidants, and mixtures thereof; and
wherein the apple base comprises particles, wherein 90 volume percent of the particles have a diameter less than or equal to 450 micrometers.

31. The apple base of claim 30, wherein 90 volume percent of the particles have a diameter less than or equal to 350 micrometers.

32. The apple base of claim 30, wherein the apple base has a percent soluble solids of about 9 to about 11 brix.

33. The apple base of claim 30, wherein the apple base has less than or equal to 2 percent intact cells.
